(19) United States
(12) Patent Application Publication
(10) Pub. No.: US 2021/0064677 A1
(43) Pub. Date: Mar. 4, 2021

(54) ONLINE SEARCH TRENDING TO PERSONALIZE CUSTOMER MESSAGING

(71) Applicant: Bank of America Corporation, Charlotte, NC (US)

(72) Inventor: David A. Stern, Wyckoff, NJ (US)

(21) Appl. No.: 16/551,545

(22) Filed: Aug. 26, 2019

(51) Int. Cl. G06F 16/9535; G06F 16/29; G06F 16/9538; G06F 16/9537; G06N 3/08; G06N 5/02

(52) U.S. Cl. CPC G06F 16/9535; G06F 16/29; G06N 5/025; G06F 16/9537; G06N 3/08; G06F 16/9538

(57) ABSTRACT

Aspects of the disclosure include methods and systems that use online search trending to inform and dynamically control a determination of which content is displayed on digital display systems. Examples of such content may include, but is not limited to messages, offers, content, tutorials, educational materials, and/or other information. In one example, the displayed content may be tailored based on online activity trending in a specific geographic area.

### TECHNICAL FIELD

Aspects of the disclosure relate to controlling digital display systems. In particular, aspects of the disclosure leverage the aggregation of online activity within a geographic area to generally personalize messaging on digital display systems.

### BACKGROUND

Display devices are ubiquitous—they appear in several forms and in numerous locations. Meanwhile, enterprise organizations may use various computing infrastructure to conduct business with their customers. These enterprise organizations may wish to leverage existing display devices, but lack the technical features to seamlessly, and without friction, interface with a group of customers in the vicinity of these display devices. In many instances, it is difficult to predict, update, and display the appropriate content in a timely and effective manner at a plurality of display devices in a region. This disclosure addresses several of the shortcomings in the industry.

### SUMMARY

Aspects of the disclosure provide technical solutions that address and overcome the technical problems associated with dynamically controlling a determination of which content is displayed on a digital display system, which is communicatively coupled to a remote computer network. The digital display system comprises a display device and a controller configured to update the content rendered on the display device based on one or more rules. The rules may comprise updating the displayed content based on one or more characteristics (e.g. a profile) of the financial center at which the digital display system is located, an upcoming event in the geographic area, and/or based on online activity trending in a specific geographic area.

In accordance with one or more embodiments, a system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general aspect includes a computing platform, including: a digital display system including a display device and a controller, where the digital display system is located in a specific geographic area; at least one processor; a communication interface communicatively coupled to the at least one processor; and memory storing computer-readable instructions that, when executed by the at least one processor, cause the computing platform to: retrieve a measure of online user activity trending in the specific geographic area; match, by the at least one processor, the measure of online user activity with a corresponding content using a rules mapping table stored in the memory; send, via the communication interface to the digital display system, a pointer to the corresponding content, where the pointer is to a memory address in a display content storage unit; cause the controller of the digital display system to retrieve a graphics display content stored at the memory address in the display content storage unit; and display, by the controller, on the display device, the graphics display content. Other embodiments of this aspect include corresponding computer systems, apparatus, and computer programs recorded on one or more computer storage devices, each configured to perform the actions of the methods.

Implementations may include one or more of the following features. The computing platform where the measure of online user activity trending is retrieved from an online search analytics database. The computing platform where the measure of online user activity trending is provided by an entity operating a ride and/or auto sharing smartphone application. The computing platform where the match step further includes loosely matching the corresponding content to a plurality of online user activity. The computing platform where the plurality of online user activity includes activity originating from a smarthome device operated in the specific geographic area. The computing platform where the plurality of online user activity includes activity originating from an augmented reality headset operated in the specific geographic area. The computing platform where the plurality of online user activity includes activity originating from a user's smartphone operated in the specific geographic area. The computing platform where the rules mapping table includes a neural network. The computing platform where the digital display system does not include a user's smartphone, and the digital display system includes a self-service automated teller machine. The computing platform where the rules mapping table includes an entry identifying a trending search keyword corresponding to an event venue and the entry identifies a geographic area by zip code. The computing platform where the graphics display content includes educational training materials stored in the display content storage unit at the memory address corresponding to the pointer. Implementations of the described techniques may include hardware, a method or process, or computer software on a computer-accessible medium.

These features, along with many others, are discussed in greater detail herein.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative computing environment for dynamically controlling a determination of which content is displayed on digital display systems, in accordance with one or more example embodiments;

FIG. 2A depicts an illustrative operating environment comprising a digital display system embodied in an automated teller machine (ATM), in accordance with one or more example embodiments;

FIG. 2B depicts an illustrative operating environment comprising multiple user computing devices and digital display systems, in accordance with one or more example embodiments;

FIG. 3 depicts an illustrative table used when dynamically controlling a determination of which content is to be displayed on digital display systems, in accordance with one or more example embodiments; and

FIG. 4 depicts an illustrative event sequence for dynamically controlling a determination of which content is displayed on digital display systems, in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

Methods and systems are disclosed that use online search trending to inform and dynamically control a determination of which content is displayed on digital display systems. The digital display systems may be located at a financial center, on a self-service automated teller machine, on a customer-facing kiosk, or other devices including a digital display communicatively coupled to a remote computer network. Examples of such content may include, but is not limited to messages, offers, content, tutorials, educational materials, and/or other information.

In some examples, the displayed content may be tailored based on one or more characteristics (e.g. a profile) of the financial center at which the digital display system is located, an upcoming event in the geographic area, and/or based on online activity trending in a specific geographic area. One example of online activity trending in a specific geographic area may be online search keywords detected at computing devices with IP addresses in the specific geographic area. This disclosure uses the word “trending” to indicate the real-time or near real-time nature of the determination described, in some examples, with respect to the content rendered on the digital display system. That is, “trending” implies an in-process, time-bound nature of the determination, as contrasted to trends that may span over many months or the past year(s).

Examples of computing devices with IP addresses in the specific geographic area include, but are not limited to, a conventional laptop computer connected via a wireless router located in the specific geographic area; a smartphone device with one or more sensors; a smarthome device comprising a microphone and speaker, and that receives audible user search requests; an augmented reality (AR) headset or eye glasses that provides information to a user based on one or more physical cues; and other electronic devices that permit a user to request and receive search results.

In one example, a profile of all users in a specific geographic area may be aggregated and considered in bulk to make a determination as to which content to render on a digital display system. In such an example, the individual user profiles might not be separately considered by the modules in determining which content to render. Rather, the user profiles may be considered in the aggregate such that the personalization of the message is not necessarily targeted to a single user. Rather, the digital display system may render content personalized for a group of users/customers, and not just one user/customer.

In one example in accordance with several aspects of the disclosure, if a music concert (or other event) is in town for a weekend and is a cash-only event, the system will use the methods and apparatuses disclosed herein to identify which specific geographic areas include users/customers that are highly likely to be attending the event. Then, the system publishes updated content to digital display systems located in those specific geographic areas to offer predictive notifications to help those that view the display device to prepare for the event.

Specifically, in the aforementioned example, after predicting that users in a specific geographic area likely may be heading to the music concert, the system may send a push notification to one or more display devices in that geographic area. In one example, the system may detect any user devices in a geographic area or within a predetermined proximity of the geographic area, and then transmit a push notification for rendering on a display device on those user devices. For example, one such push notification message might read: “Here are where three ATMs are located along your way to the concert, in case you need to withdraw cash.”

In some example, the system may also send instructions (e.g. in the form of a push notification comprising machine-readable code) that cause it to pre-stage transactions at the ATMs that are along the way to the concert. In other examples, a financial center may also prepare itself for upcoming specific needs of the customers based on the system.

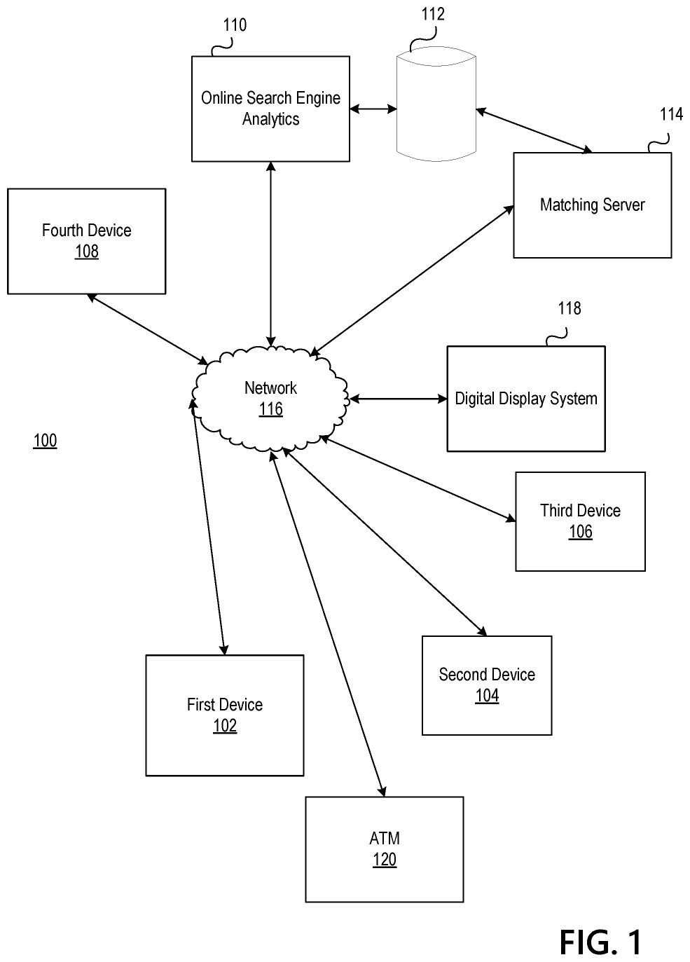

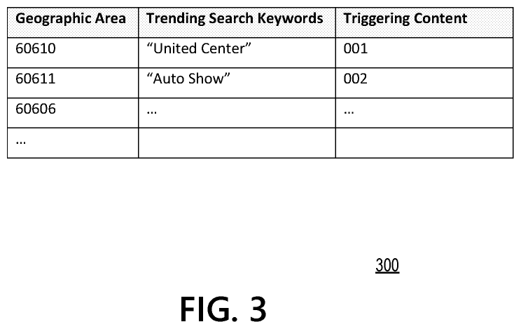

Referring to FIG. 1, that figure depicts an illustrative computing environment for dynamically controlling a determination of which content is displayed on digital display systems, in accordance with one or more example embodiments. In FIG. 1, the computing environment 100 may include one or more computer systems. For example, computing environment 100 may include a plurality of user devices 102, 104, 106, 108 being used for online searching and other online functionality; an online search engine analytics engine 110 that aggregates online search queries and stored it in a data store 112; a digital display system 118 and automated teller machine (ATM) 120 comprising a digital display; and a matching server 114 that stores a rules mapping table (see FIG. 3). One or more of the aforementioned components may be communicatively coupled over a network 116.

As illustrated in greater detail herein, computing platform 114 may include one or more computers (e.g., laptop computers, desktop computers, tablets, smartphones, or the like). Moreover, the illustrative first, second, third, and fourth user devices 102, 103, 104, 105 may be a personal computing device (e.g., desktop computer, laptop computer) or mobile computing device (e.g., smartphone, tablet, wearable device). In addition, each user device may be linked to and/or used by a specific user. For example, the user associated with second device 104 may use the second device 104 to perform online searches or order a ride-sharing/auto-sharing service request.

Computing environment 100 also may include one or more networks 116, which may interconnect one or more of aforementioned devices illustrated in FIG. 1. In some embodiments, network 116 may be configured to send and receive messages via different protocols, e.g. Bluetooth, Wireless Fidelity (“Wi-Fi”), near field communication (“NFC”), cellular, and/or other protocols that enable device to device communication over short distances.

In one or more arrangements, one or more of aforementioned devices illustrated in FIG. 1 may be any type of computing device capable of receiving a user interface, receiving input via the user interface, and communicating the received input to one or more other computing devices. For example, the aforementioned devices, in some instances, may be and/or include server computers, desktop computers, laptop computers, tablet computers, smart phones, or the like that may include one or more processors, memories, communication interfaces, storage devices, and/or other components. And, in some instances, they may be special-purpose computing devices configured to perform specific functions.

Referring to FIG. 1, matching server 114 may include one or more processors, memory, and communication interface. A data bus may interconnect processor, memory, and communication interface. The communication interface may be a network interface configured to support communication between matching server 114 and one or more devices on the network. The memory may include one or more program modules having instructions that when executed by processor cause server 114 to perform one or more functions described herein and/or one or more databases that may store and/or otherwise maintain information which may be used by such program modules and/or processor. In some instances, the one or more program modules and/or databases may be stored by and/or maintained in different memory units of computing platform and/or by different computing devices that may form and/or otherwise make up computing platform.

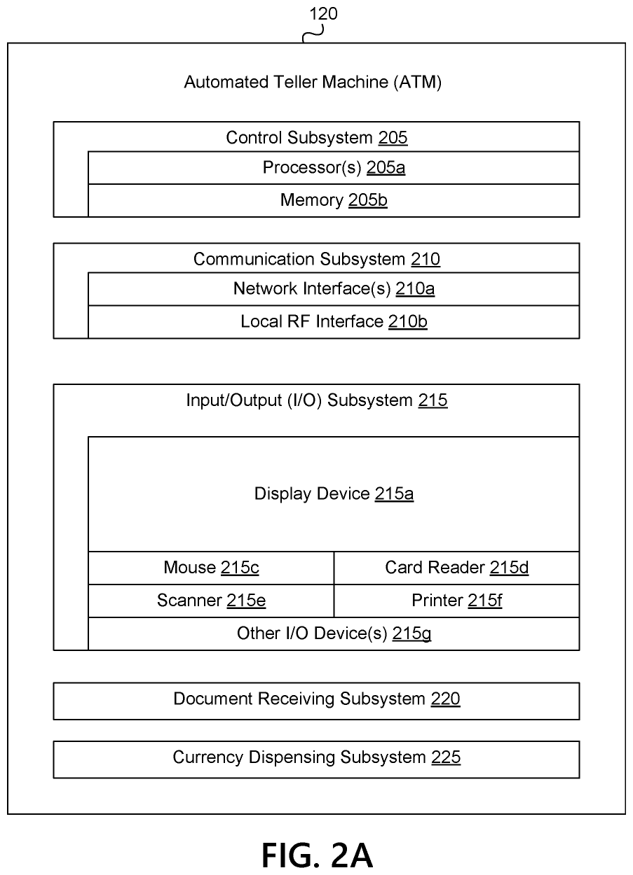

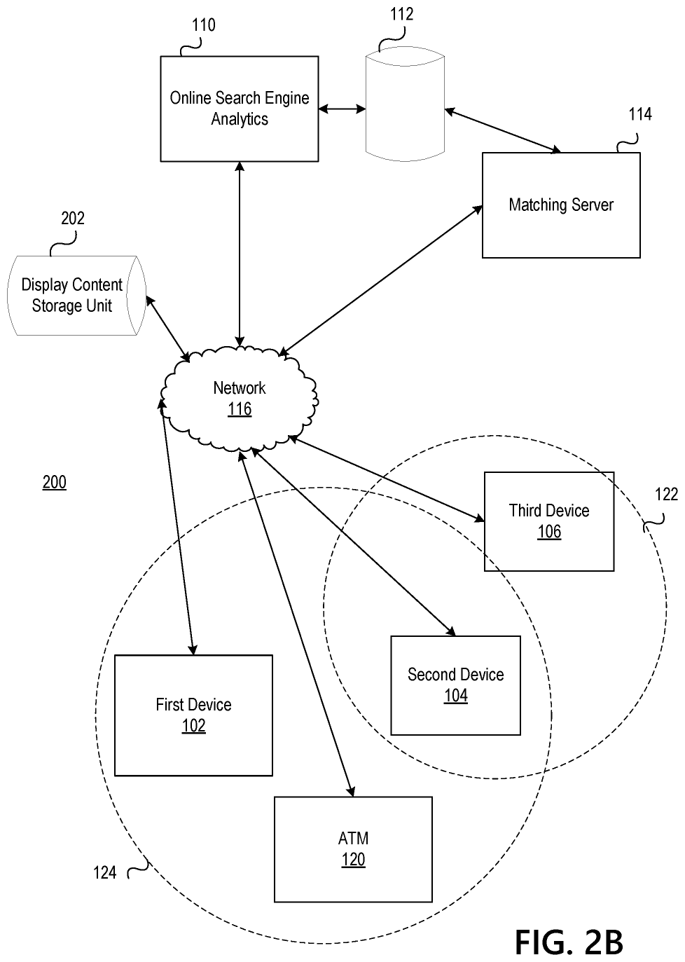

FIG. 2A illustrates an example of an automated teller machine (ATM) 200 according to one or more aspects of the disclosure. As discussed herein, an “automated teller machine,” such as ATM 200, may include and/or incorporate one or more computing devices and/or one or more other components and/or devices that may enable the automated teller machine to receive user input (e.g., from customers of a financial institution), connect to and/or communicate with other devices and/or servers (which may, e.g., include other devices and/or servers that are operated and/or controlled by a financial institution), and/or process transactions (which may, e.g., be requested by users of the automated teller machine and may, for instance, include currency withdrawal transactions, current deposit transactions, check deposit transactions, balance inquiry transactions, and/or other types of transactions). In some instances, the term “automated teller machine,” as used herein, thus may include conventional automated teller machines, as well as other types of similar systems, including automated teller assistants, video teller assistants, and/or other types of currency handling devices.

As seen in FIG. 2A, ATM 200 may include various subsystems that may exchange digital information and/or analog electrical signals with each other via wired and/or wireless connections to facilitate operation of the ATM 200 and/or execution of the various functions that the ATM 200 may provide. In one or more arrangements, ATM 200 may include a control subsystem 205, a communication subsystem 210, an input/output (I/O) subsystem 215, a document receiving subsystem 220, and a currency dispensing subsystem 225. While these subsystems are discussed herein as examples of the subsystems that may be included in ATM 200 in some embodiments, the ATM 200 may, in other embodiments, include additional and/or alternative subsystems than those discussed with respect to FIG. 2A. For instance, one or more of the example subsystems may be combined and/or replaced by other subsystems that may enable ATM 200 to provide similar, additional, and/or alternative functionalities.

In some embodiments, control subsystem 205 may be configured to monitor, manage, command, and/or otherwise control one or more of the other subsystems included in ATM 200, as well as the overall operations of and/or functionalities provided by the ATM 200. For example, control subsystem 205 may include one or more processors 205a and memory 205b. The one or more processors 205a may, for instance, be configured to receive and/or process information and/or signals received from other subsystems, and may be further configured to send commands, other information, and/or various signals to the other subsystems included in ATM 200. In addition, memory 205b may be configured to store computer-readable instructions and/or other information that may cause the one or more processors 205a to execute various programs and/or that may be otherwise used by the one or more processors 205a.

In some embodiments, communication subsystem 210 may be configured to send, receive, and/or otherwise facilitate communications between ATM 200 and one or more servers and/or other computing devices. For example, communication subsystem 210 may include one or more network interfaces 210a and/or one or more local radiofrequency (RF) interfaces 210b. The one or more network interfaces 210a may, for instance, include one or more wired and/or wireless communications interfaces, such as one or more Ethernet interfaces, one or more IEEE 802.11a/b/g/n interfaces, one or more cellular interfaces (e.g., CDMA interfaces, GSM interfaces, and/or the like), and/or one or more other interfaces. The one or more network interfaces 210a may, for example, enable the ATM 200 to communicate with one or more servers and/or other devices via various networks, which may include local area networks (LANs), wireless local area networks (WLANs), cellular networks, and/or other networks. In addition, the one or more local RF interfaces 210b may, for instance, include one or more short-range wireless communication interfaces, such as one or more near field communications (NFC) interfaces, one or more Bluetooth interfaces, and/or one or more other interfaces. The one or more local RF interfaces 210b may, for instance, enable the ATM 200 to communicate with a local device, such as a mobile computing device used by a user of the ATM 200, that may be within close range of (and/or otherwise within a predetermined distance of) the ATM 200.

In some embodiments, input/output (I/O) subsystem 215 may be configured to receive one or more types of input (e.g., from a user of the ATM 200) and/or provide one or more types of output (e.g., to the user of the ATM 200). For example, I/O subsystem 215 may include a display device 215a, a keypad 215b, a mouse 215c, a card reader 215d, an optical scanner 215e, a printer 215f, and/or one or more other I/O devices 215g that each may be configured to receive and/or provide various types of input and/or output. The display device 215a may, for instance, be configured to display and/or otherwise provide graphical and/or video output to a user of the ATM 200. In some instances, display device 215a may include a touchscreen that may, for instance, be configured to receive input from a user of the ATM 200 via one or more touch-sensitive surfaces. In addition, keypad 215b may, for instance, include one or more buttons that are configured to allow a user of the ATM 200 to provide character input, and mouse 215c may be configured to allow the user to move a cursor and select items included in a user interface. Card reader 215d may, for instance, include one or more receptacles, magnetic stripe readers, chip readers, and/or the like, and may be configured to physically receive and electronically obtain information from a payment card, such as a debit card or credit card. Optical scanner 215e may, for instance, include one or more cameras and may be configured to capture an image and obtain information from items included in the image, such as one or more barcodes and/or quick response (QR) codes. Printer 215f may, for instance, be configured to print one or more receipts and/or other documents that may provide physical output to a user of the ATM 200. Furthermore, one or more other input and/or output devices 215g may receive and/or provide additional and/or alternative types of input and/or output to a user of the ATM 200.

In some embodiments, document receiving subsystem 220 may be configured to receive various types of documents (e.g., from a user of the ATM 200 who may, for instance, be depositing funds and/or otherwise submitting one or more documents for processing by a financial institution operating the ATM 200). For example, document receiving subsystem 220 may include one or more currency receiving devices and/or one or more document receiving devices. The one or more currency receiving devices may, for instance, include one or more slots, rollers, scanners, cartridges, and/or other components that may be configured to physically receive, process, and/or store various types of currency (e.g., coins, bills, and/or other types of currency). In addition, the one or more document receiving devices may, for instance, include one or more slots, rollers, scanners, cartridges, and/or other components that may be configured to physically receive, process, and/or store various types of financial documents (e.g., checks).

In some embodiments, currency receiving subsystem 225 may be configured to dispense various types of currency and/or other items (e.g., to a user of the ATM 200 who may, for instance, be withdrawing funds and/or otherwise obtaining documents and/or other items from the ATM 200). For example, currency dispensing subsystem 225 may include one or more bill dispensing devices, one or more coin dispensing devices, and/or one or more other dispensing devices. The one or more bill dispensing devices may, for instance, include one or more slots, rollers, scanners, cartridges, and/or other components that may be configured to physically dispense one or more bills (e.g., to a user of the ATM 200). The one or more coin dispensing devices may, for instance, include one or more slots, rollers, scanners, cartridges, and/or other components that may be configured to physically dispense one or more coins (e.g., to a user of the ATM 200). Additionally, the one or more other dispensing devices may, for instance, include one or more slots, rollers, scanners, cartridges, and/or other components that may be configured to dispense one or more other items to a user of the ATM 200.

As noted herein, while the ATM 200 and the various subsystems and/or other devices discussed above illustrate one or more example arrangements of an automated teller machine in some embodiments, one or more other subsystems and/or devices may be included in an automated teller machine in addition to and/or instead of those discussed herein in other embodiments.

Having described an example of a computing device that can be used in implementing various aspects of the disclosure and an operating environment in which various aspects of the disclosure can be implemented, as well as an example of an automated teller machine that may be used in implementing some aspects of the disclosure, several embodiments will now be discussed in greater detail.

FIG. 2B depicts an illustrative operating environment 200 comprising multiple user computing devices and digital display systems, in accordance with one or more example embodiments. The profile of all user devices 102, 104 in a specific geographic area 124 may be aggregated and considered in bulk to make a determination as to which content to render on a digital display system 120. Alternatively, devices 106, 104 in a different geographic area 122 may be considered separately by the matching server for selection and rendering of content. The digital display system may be an automated teller machine 120 with a display device for rendering visual graphical content. In such an example, the individual user profiles of the first device 102 might not be separately considered by one or more program modules of the matching server 114 in determining which content to render at ATM 120. Rather, the user profiles may be considered in the aggregate such that the personalization of the message is not necessarily targeted to a single user. Rather, the digital display system 120 may render content personalized for a group of users/customers, and not just one user/customer. The content may be stored in a data store 202 and identified by a rule mapping table 300 stored at (or readily accessible to) the matching server 114.

FIG. 3 depicts an illustrative rule mapping table 300 used when dynamically controlling a determination of which content is to be displayed on digital display systems, in accordance with one or more example embodiments. The rule mapping table 300, in one example, may comprise values indicative of geographic area (e.g., zip code), trending search keywords (e.g., search queries), and the triggering content that maps to the corresponding tuples in the table 300. The value in the “triggering content” column may, in some examples, be a memory pointer to a display content storage unit 202. The memory pointer may identify the start of a graphics file, or other type of file, that is to be processed and/or transmitted to a digital display system 120 for rendering on the device display of the system 120. Of course, the trending search keyword column in the table 300 may include synonyms of the primary keyword and other related information indicative of the particular content. In another example, an “Auto show” search keyword may suggest that users in the 60611 zip code are interested in attending an auto show and purchasing a vehicle. As a result, the digital display system 120 may display information about deals on auto loans. In other words, the content is generally targeted to a group of users in a geographic area, but not specifically a single or particular user.

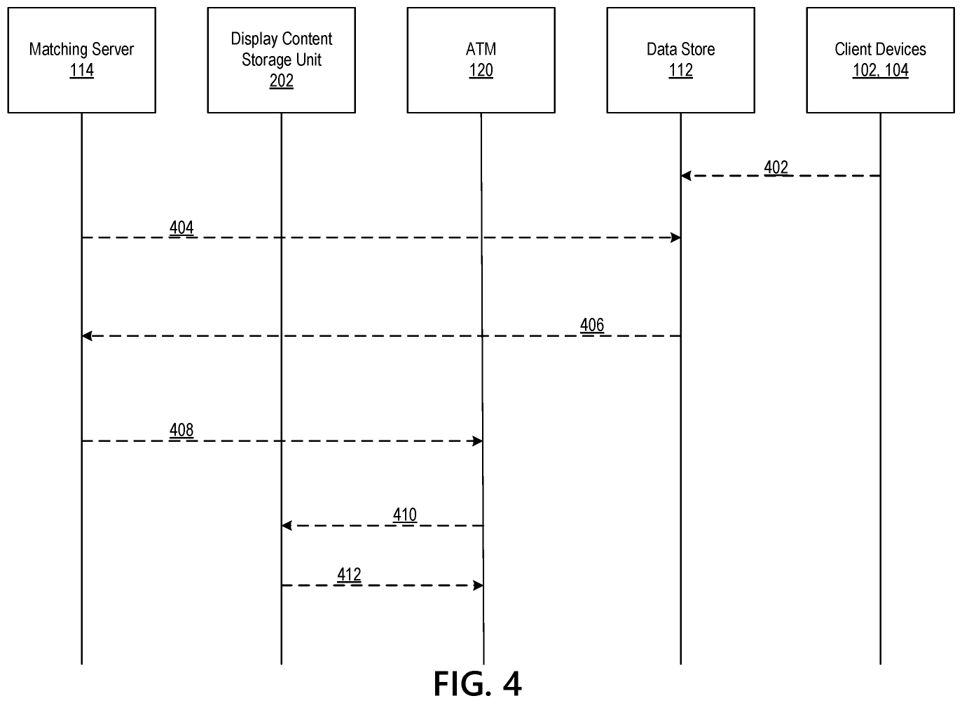

FIG. 4 depicts an illustrative event sequence for dynamically controlling a determination of which content is displayed on digital display systems, in accordance with one or more example embodiments. At step 402, online search query analytics (and other online activity information) originating from client devices 102, 104 are stored in a data store 112 in aggregate. Therefore, when the matching server 114 requests, in step 404, retrieval of a measure of online user activity trending in a specific geographic area, the data is available at data store 112. The matching server 114 receives the appropriate information in step 406 so that it may match, using its computer processor and a rules mapping table stored in the memory, the measure of online user activity with corresponding content stored in a storage unit 202. Having identified the appropriate content in the storage unit 202, the matching server 114 transmits (in step 408) the memory pointer (and any other information) to the ATM 120 for rendering on the display device of the ATM 120. Then, the ATM 120 may itself directly request, in step 410, the content from the storage unit 202. Upon receipt of the content, in step 412, the ATM 120 may render it on its digital display for all users in the geographic area to view.

In some embodiments, one or more of the aforementioned steps of FIG. 4 may use a system of machine learning and/or artificial intelligence to improve accuracy of the determination. A framework for machine learning may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human brain). Such structures, while significantly more complex than conventional computer systems, are beneficial in implementing machine learning. For example, an artificial neural network may be comprised of a large set of nodes which, like neurons in the brain, may be dynamically configured to effectuate learning and decision-making. Moreover, machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator.

In an embodiment involving supervised machine learning, a graph module corresponding to an artificial neural network may receive and execute instructions to modify the computational graph. A supervised machine learning model may provide an indication to the graph module that output from the machine learning model was correct and/or incorrect. In response to that indication, the graph module may modify one or more nodes and/or edges to improve output. The modifications to the nodes and/or edges may be based on a prediction, by the machine learning model and/or the graph module, of a change that may result an improvement. The modifications to the nodes and/or edges may be based on historical changes to the nodes and/or edges, such that a change may not be continuously made and unmade (an undesirable trend which may be referred to as oscillation). Feedback may be additionally or alternatively received from an external source, such as an administrator, another computing device, or the like. Where feedback on output is received and used to reconfigure nodes and/or edges, the machine learning model may be referred to as a supervised machine learning model.

In supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of one hundred photos with labeled human faces and ten thousand random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”).

In one example, the machine learning engine may identify relationships between nodes that previously may have gone unrecognized, for example, using collaborative filtering techniques. This realization by the machine learning engine may increase the weight of a specific node; and subsequently spread weight to connected nodes. This may result in particular nodes exceeding a threshold confidence to push those nodes to an updated outcome from a Boolean false to a Boolean true. Other examples of machine learning techniques may be used in combination or in lieu of a collaborative filtering technique.

In addition, one theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (2) regression functions where the function being learned is continuous; and (3) probability estimations where the output of the function is a probability.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

In some embodiments, one or more of the aforementioned steps of FIG. 4 may use a system of machine learning and/or artificial intelligence to improve accuracy of the determination. As explained herein, a framework for machine learning may involve a combination of supervised and unsupervised learning models.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed herein may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform, comprising:
a digital display system comprising a display device and a controller, wherein the digital display system is located in a specific geographic area;
at least one processor;
a communication interface communicatively coupled to the at least one processor; and
memory storing computer-readable instructions that, when executed by the at least one processor, cause the computing platform to:
retrieve a measure of online user activity trending in the specific geographic area;
match, by the at least one processor, the measure of online user activity with a corresponding content using a rules mapping table stored in the memory;
send, via the communication interface to the digital display system, a pointer to the corresponding content, wherein the pointer is to a memory address in a display content storage unit;
cause the controller of the digital display system to retrieve a graphics display content stored at the memory address in the display content storage unit; and
display, by the controller, on the display device, the graphics display content.

2. The computing platform of claim 1, wherein the measure of online user activity trending is retrieved from an online search analytics database.

3. The computing platform of claim 1, wherein the measure of online user activity trending is provided by an entity operating a ride-sharing or auto-sharing smartphone application.

4. The computing platform of claim 1, wherein the match step further comprises loosely matching the corresponding content to a plurality of online user activity.

5. The computing platform of claim 4, wherein the plurality of online user activity comprises activity originating from a smarthome device operated in the specific geographic area.

6. The computing platform of claim 4, wherein the plurality of online user activity comprises activity originating from an augmented reality headset operated in the specific geographic area.

7. The computing platform of claim 4, wherein the plurality of online user activity comprises activity originating from a user's smartphone operated in the specific geographic area.

8. The computing platform of claim 4, wherein the rules mapping table comprises a neural network.

9. The computing platform of claim 1, wherein the digital display system does not comprise a user's smartphone, and the digital display system comprises a self-service automated teller machine.

10. The computing platform of claim 1, wherein the rules mapping table comprises an entry identifying a trending search keyword corresponding to an event venue and the entry identifies a geographic area by zip code.

11. The computing platform of claim 1, wherein the graphics display content comprises educational training materials stored in the display content storage unit at the memory address corresponding to the pointer.

12. A method, comprising:
at a computing platform comprising at least one processor, a communication interface, a memory, and a digital display system:
retrieve a measure of online user activity trending in a specific geographic area, wherein the digital display system is located in the specific geographic area;
match, by the at least one processor, the measure of online user activity with a corresponding content using a rules mapping table stored in the memory;
send, via the communication interface to the digital display system, a pointer to the corresponding content, wherein the pointer is to a memory address in a display content storage unit;
cause a controller of the digital display system to retrieve a graphics display content stored at the memory address in the display content storage unit; and
display, by the controller, on a display device of the digital display system, the graphics display content.

13. The method of claim 12, wherein the measure of online user activity trending is provided by at least one of an entity operating a ride sharing smartphone application, an entity operating an auto sharing smartphone application, and an online search analytics database.

14. The method of claim 12, wherein the plurality of online user activity comprises activity originating from a smarthome device operated in the specific geographic area

15. The method of claim 12, wherein the plurality of online user activity comprises activity originating from an augmented reality headset operated in the specific geographic area.

16. The method of claim 12, wherein the rules mapping table comprises a neural network.

17. The method of claim 12, wherein the rules mapping table comprises an entry identifying a trending search keyword corresponding to an event venue and a geographic area.

18. The method of claim 12, wherein the graphics display content comprises an educational tutorial stored in the display content storage unit at the memory address corresponding to the pointer.

19. One or more non-transitory computer-readable media storing instructions that, when executed by a computing platform comprising at least one processor, a communication interface, a memory, and a digital display system, cause the computing platform to:
retrieve a measure of online user activity trending in a specific geographic area, wherein the digital display system is located in the specific geographic area;
match, by the at least one processor, the measure of online user activity with a corresponding content using a rules mapping table stored in the memory;
send, via the communication interface to the digital display system, a pointer to the corresponding content, wherein the pointer is to a memory address in a display content storage unit;
cause a controller of the digital display system to retrieve a graphics display content stored at the memory address in the display content storage unit; and
display, by the controller, on a display device of the digital display system, the graphics display content.

20. The non-transitory computer-readable media of claim 19, wherein the digital display system comprises a self-service automated teller machine.
